(19) United States
(12) Patent Application Publication
(10) Pub. No.: US 2004/0001041 A1
(43) Pub. Date: Jan. 1, 2004

(54) Scrollbar-less control button and method

(76) Inventors: Peterson Chang, Changhua (TW); Stone Cheng, Kaohsiung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,577

(22) Filed: Jul. 29, 2002

(30) Foreign Application Priority Data
Jul. 1, 2002 (TW) 91114488

(51) Int. Cl. G09G 5/00

(52) U.S. Cl. 345/156

(57) ABSTRACT

Control button and method without using a scroll bar. A scrollbar-less control button is used to control page up, page down, page left, page right, and page flip, allowing the user to control the functions of the control button within a restricted range. Therefore, not only is the range for dragging the mouse up or down, left or right reduced, but the available space of user window interface is also greatly increased.

### BACKGROUND OF INVENTION

1. Field of the Invention

The invention relates in general to a control button and an operation method of the same, and more particularly, to a control button and an operation method without using a scroll bar.

2. Related Art of the Invention

Currently, when a user interface window (such as Microsoft Word) is activated, the reserved space for up/down scrolling bar and left/down scrolling bar greatly reduces the available space of the user interface window. As shown in FIG. 1, the conventional interface window 10 with an up/down scroll bar 102 and a left/right scroll bar 104, occupies significant available access space for the user. Further, while accessing a document, the very long scrolling range of the up/down and left/right scroll bars 102 and 104 causes application inconvenience by having a very large operation range for a mouse used by the user.

The conventional up/down scroll bar and left/right scroll bar of the user interface window thus has the following disadvantages. First, the reserved space occupied thereby greatly reduces the available space of the interface window that the user can access. Second, the scrolling range thereof results in a very large range for operating a mouse.

### SUMMARY OF INVENTION

The present invention provides a control button and an operation method thereof without using the scroll bar to control functions of page up/down, page left/right, and page flip. Therefore, the required working range for the user to control left, right, up and down is reduced, and available access space of the window is enlarged.

The present invention provides a control button to replace a scroll bar. The control button is located in the user interface window. When a document is opened, depending on the screen resolution used to display the document, the control button is displayed when the document is larger than the window. The control button comprises a control button panel and a status display region. By moving the cursor into the control button panel and selecting a mouse contact control, the control button automatically scrolls the document along a default direction with a default speed. The scrolling direction and speed can be set up as desired. When the control button is controlled by mouse clicking, the document is scrolled according to the default configuration of the mouse. In the status display region, a first color is displayed when the user selects controlling the document with the mouse contact control, and a second color is displayed when the mouse clicking control is select.

Preferably, when the document does not exceed the display region of the window, the control button is automatically hidden.

Preferably, the position of the control button is movable.

In one embodiment, when the user clicks the right button of a mouse over the control button, the context menu of the control button is displayed. The menu includes the automatic operation speed of the control button under mouse contact status, the clicking response speed, the moving direction precision and several predetermined parameters.

Preferably, the automatic operation of the control button and the mouse clicking option is switched by clicking the mouse and displayed on the status display region.

In one embodiment, the automatic operation is the automatic mode, while the mouse clicking option is the selection mode.

In one embodiment, the first color is translucent white, while the second color is gray.

The present invention further provides an operation method for a control button without a scroll bar. The control button is located in a user interface window. When a document is opened, according to the resolution of screen used to display the document, the control button is displayed on the screen when the document exceeds the display region of the user interface window. In the operation method, the mouse is moved into the control button panel of the control button. The document is automatically shifted with a default speed and a default shifting direction precision by the control button under the mouse contact mode. When the user uses the mouse to click the control button panel, the document is shifted according to the default clicking response and shifting direction precision.

Preferably, when the document does not exceed the display region of the user interface window, the control button is automatically hidden.

Preferably, the control button can be dragged to other positions in the user interface window.

In one embodiment of the present invention, by clicking the right button of the mouse over the control button panel, the context menu of the control button is displayed. The menu allows the user to set up the automatic moving speed, clicking response speed, moving direction precision and several predetermined parameters.

In one embodiment of the present invention, the automatic moving control is an automatic mode, while the mouse clicking control is a selection mode.

In one embodiment of the present invention, the automatic moving control and the mouse clicking control are switched in the status display region.

When the automatic moving control is selected, the status display region displays a first color. The first color includes translucent white.

When the mouse clicking control is selected, the status display region displays a second color. The first color includes gray.

According to the above, the present invention provides a control button to replace the scroll bar to control moving up/down and left/right of a page and flipping a page.

Therefore, the left, right, up and down movement required by the user is reduced, while the accessible space of the user interface window is greatly increased.

### BRIEF DESCRIPTION OF DRAWINGS

These, as well as other features of the present invention, will become more apparent upon reference to the drawings wherein:

FIG. 1 shows a conventional user interface window with an up/down scroll bar and a left/right scroll bar;

FIG. 2 outlines the user interface window using the control button provided by the present invention;

FIG. 3 outlines another user interface window using the control button provided by the present invention;

FIG. 4 shows the context menu of the control button in one embodiment of the present invention; and

FIG. 5 shows the operation process of the control button in one embodiment of the present invention.

### DETAILED DESCRIPTION

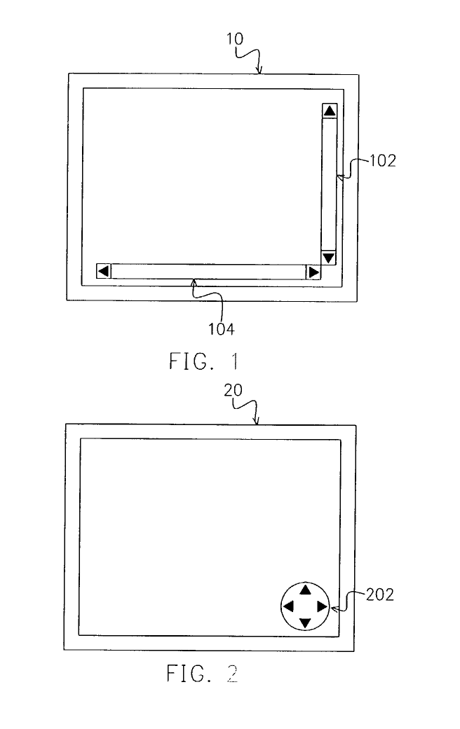

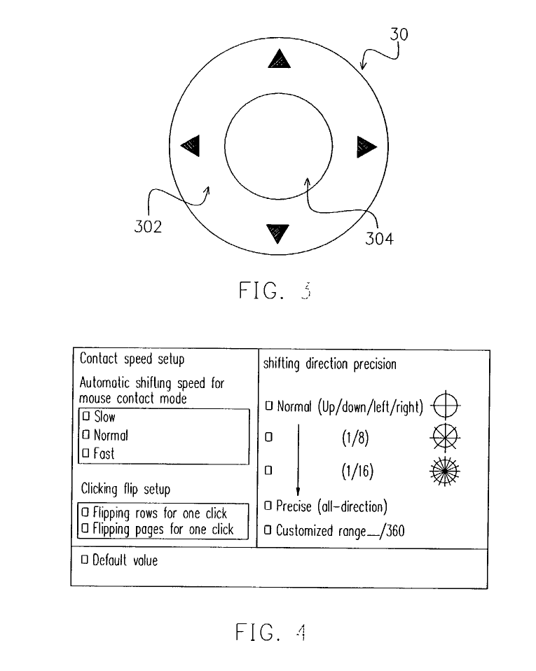

FIG. 2 shows a user interface window 20 with a control button 20 according to the present invention. Based on the operation convenience of the user, the position of the control button 20 can be shifted as required. As shown in FIG. 2, unlike the conventional scroll bar, the control button 202 occupies only a small space of the user interface window 202. Therefore, the effort for scrolling the page up and down, left and right using the conventional scroll bar is significantly moderated, and the available space of the user interface window is increased.

Referring to FIG. 3, an exterior feature of the control button 30 in one embodiment of the present invention is shown. The control button 30 is located in the user interface window. When a document is opened, the control button 30 is displayed according to the screen resolution. More specifically, the control button is displayed when the document is oversized in the user interface window; and is hidden when the document is not oversized in the user interface window. For example, when the document is opened, for a screen resolution of 1024×768 pixels, the control button 30 is automatically displayed or hidden, depending on the determination of whether the document is oversized in the user interface window based on the resolution.

The control button 30 comprises a control button panel 302 and a status display region 304. When the current document-scrolling mode is an automatic mode, by dragging the mouse on top of the control button panel 302, the mouse contact of the control button panel 302 allows the document to move or to be scrolled with a default speed and a default direction precision. When the current document-scrolling mode is a mouse-clicking mode, the document is shifted or scrolled when the mouse clicks the control button panel 302. The document is then shifted or scrolled with the default mouse clicking response and a default shifting direction precision. The current document-mode is displayed in the status display region 304. For example, when a color such as white translucent is shown in the status display region 304, it indicates that the automatic mode has been selected as the current document-scrolling mode. In contrast, when another color such as gray is displayed in the status display region 304, it indicates that the mouse clicking control in the document is currently controlled to scroll or shift by mouse clicking.

The status shown by the status display region 304 includes the mouse contact mode and the mouse-clicking mode, which are also referred as the automatic mode and selection mode, respectively. That is, the automatic mode shifts the document shifted with a default speed in a default direction, while the selection mode allows the document to be shifted according to clicking operation of the mouse. In the selection mode, the user can shift or scroll the document with a speed corresponding to the clicking response of the mouse along a direction as required. For example, one can choose between the up, down, right and left arrows of the control button panel 304 as shown in FIGS. 2 and 3. The control for scrolling the document is switchable between the automatic mode and the mouse-clicking mode by dragging the mouse to click the status display region 304. For example, when the status display region 304 is white, one can use the mouse to click the status display region 304 to switch to the mouse-clicking mode. Consequently, the color shown in the status display region 304 is converted from white to gray. On the contrary, when the current color displayed in the status display region 304 is gray, one can drag the mouse and click the status display region 304 to select the automatic mode. Meanwhile, the color is converted from gray to white.

The contact menu of the control button 30 is illustrated in FIG. 4. When the user presses the right button of the mouse on the control button panel, the context menu is displayed, and the function configuration is commenced. As shown in FIG. 4, the context menu comprises the automatic scrolling speed of the mouse contact (that is, the setup of contact speed), the clicking flip setup, the direction precision and various pre-set values. In this embodiment, the speed of the mouse contact can be configured slow, normal or fast. The clicking flip setup includes row flipping or page flipping set up. The direction precision can be configured as normal (that is, up, down, left and right), ⅛, 1/16, precise (full orientation), or user-defined range (which can be set up as a multiple of 1/360). After setting up the status, the status setup can be saved as default values for the control button to control document scrolling. For example, when the document scrolling speed is set slow in the automatic control, the direction precision can be configured as 1/16, and these configurations are saved as default values. Alternatively, in the mouse clicking control, the clicking flip can be configured as flipping to next row by one click, and the direction precision can be set as 3/360. These setups are then saved as the-default values.

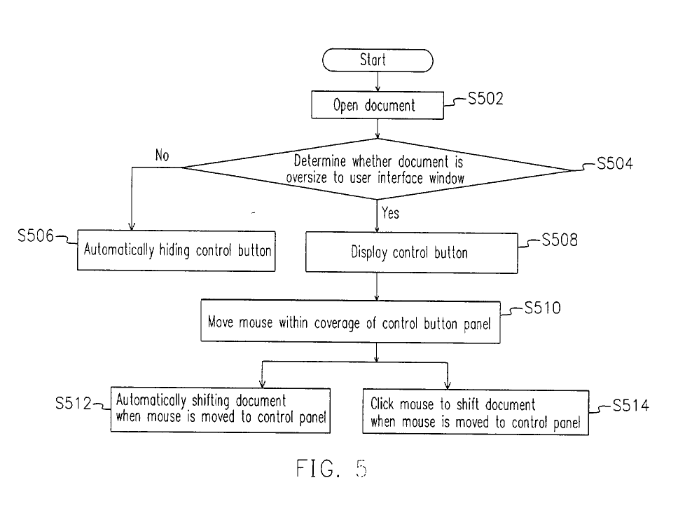

FIG. 5 shows the flow chart of the operation method of the control button. When the document is opened in step s502, whether the document is oversize in the user interface window is determined according to the current screen resolution in step 504. If the document is not oversize in the user interface window, the control button 30 is automatically hidden in step s506. If the document is oversize in the user interface window, the control button 30 is displayed in step s508. The mouse is shifted or dragged to the coverage of the control button 30. When the mouse contact control is the current control mode with a default shifting speed and shifting direction precision, a corresponding color (white translucent, for example) is displayed in the status display region 304 (step s512). When the mouse clicking control of the button panel is the current mode, the document is shifted according to the mouse click default and the shifting direction precision. Meanwhile, the status display region 304 displays another color (gray, for example) (step s514).

According to the above, the present invention replaces the scroll bar with the control button to control page up/down, left/right and flip. Therefore, the user can successfully control the page within a small and fixed range. The required working range for the user is thus reduced, and the available space of the user interface window is effectively increased.

Other embodiments of the invention will appear to those skilled in the art from consideration of the specification and practice of the invention disclosed herein. It is intended that the specification and examples are to be considered as exemplary only, with a true scope and spirit of the invention being indicated by the following claims.

1. A scrollbar-less control button, located in a user interface window when a document is opened, the control button being displayed in the user interface window when the document is oversize in the user interface window according to a screen resolution, the control button comprising:
a control button panel, operative to shift the document while being in contact with a mouse or clicked by the mouse; and
a status display region, operative to provide and display options between a mouse contact mode in which the mouse is in contact with the control button panel to automatically shift the document with a default shifting speed and a default shifting direction precision, and a mouse clicking mode in which the control button panel is clicked by the mouse to shift the document manually with a default clicking configuration and a default direction precision.

2. The control button according to claim 1, wherein the control button is automatically hidden when the document is not oversize in the user interface window.

3. The control button according to claim 1, wherein the control button is automatically displayed when the document is oversize in the user interface window.

4. The control button according to claim 1, wherein functions of the control button are configurable and displayed by pressing a right button of the mouse on the control button panel.

5. The control button according to claim 4, wherein the functions comprise automatic shifting speed of the mouse contact mode, the clicking configuration, the shifting direction precision, and a default value.

6. The control button according to claim 1, wherein the status display region is operative to switch between the mouse contact mode and the mouse clicking mode by using the mouse to click thereon.

7. The control button according to claim 1, wherein the contact mode includes an automatic document-scrolling mode.

8. The control button according to claim 1, wherein the mouse clicking mode includes a selection mode.

9. The control button according to claim 1, wherein the status display regions display a first color when the mouse contact mode is selected, and displays a second color when the mouse clicking mode is selected, the first color is distinctive from the second color.

10. The control button according to claim 9, wherein the first color includes white translucent, and the second color includes gray.

11. A method of controlling shifting a document under a user interface window by a control button without using a scroll bar, wherein the control button is automatically displayed when the document is oversize in the user interface window, the method comprising:
shifting a mouse to a coverage of a control button panel to automatically shift the document with a default speed along a default direction when a mouse contact mode is shown in a status display region of the control button; and
using the mouse to click of the control button panel to shift the document along a selected direction when a mouse clicking mode is displayed in the status display region.

12. The method according to claim 11, wherein the control button is automatically hidden when the document is not oversize in the user interface window.

13. The method according to claim 11, further comprising the step of moving the control button to a required location of the user interface window.

14. The method according to claim 11, further comprising the step of configuring the control button by shifting the mouse on the control button panel and pressing a right button of the mouse.

15. The method according to claim 14, further comprising the step of configuring the default speed of the automatic mode, clicking flip, shifting direction precision, and a predetermined value.

16. The method according to claim 11, wherein the mouse contact mode includes an automatic mode.

17. The method according to claim 11, wherein the mouse clicking mode includes a selection mode.

18. The method according to claim 11, further comprising a step of moving the mouse on the status display region and clicking the status display region to select between the automatic mode and the selection mode.

19. The method according to claim 11, wherein the status display region displays a first color when the mouse contact mode is selected.

20. The method according to claim 19, wherein the first color is translucent white.

21. The method according to claim 11, wherein the status display region displays a second color distinctive to the first color when the mouse clicking mode is selected.

22. The method according to claim 21, wherein the second color is gray.
